(19) United States
(12) Patent Application Publication
(10) Pub. No.: US 2010/0027972 A1
(43) Pub. Date: Feb. 4, 2010

(54) DIGITAL PHOTO FRAME CAPABLE OF ATTRACTING ATTENTION

(75) Inventors: Han-Che Wang, Tu-Cheng (TW); Shin-Hong Chung, Tu-Cheng (TW); Kuan-Hong Hsieh, Tu-Cheng (TW); Cheng-Hao Chou, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/466,346

(22) Filed: May 14, 2009

(30) Foreign Application Priority Data
Aug. 1, 2008 (CN) 200820301690.4

(51) Int. Cl. H04N 5/91

(52) U.S. Cl. 386/96; 386/E05.003

(57) ABSTRACT

A digital photo frame (DPF) capable of attracting attention is provided. The DPF includes a storage unit, a playback unit, a motion detector and a processing unit. The memory stores a plurality of audio files. The playback unit is configured to play the audio files. The motion detector is configured to detect whether there is someone around the DPF and produce a trigger signal when there is. The processing unit is connected to the motion detector and the playback unit, and is configured to control the playback unit to play an audio file thereby attracting people's attention.

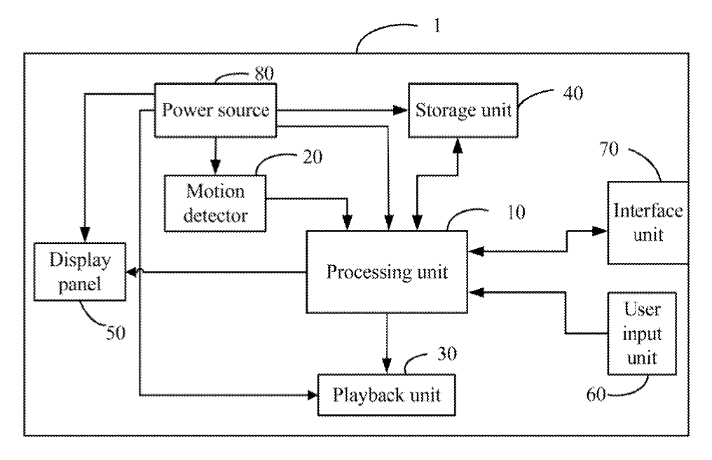

### RELATED APPLICATIONS

This application is related to copending applications entitled, “DIGITAL PHOTO FRAME CAPABLE OF AUTOMATICALLY CHANGING DISPLAY MODE”, filed ______ (Atty. Docket No. US 21363); “INTELLIGENT DIGITAL PHOTO FRAME”, filed ______ (Atty. Docket No. US21364); “DIGITAL PHOTO FRAME WITH BATTERY INDICATOR” filed **** (Atty. Docket No. US21365); and “DIGITAL PHOTO FRAME CAPABLE OF ATTRACTING ATTENTION”, filed ______ (Atty. Docket No. US21366).

### BACKGROUND

1. Technical Field

The disclosure relates to electronic devices and, particularly, to a digital photo frame.

2. Description of Related Art

Nowadays, digital photos are getting more and more popular while digital cameras are becoming more and more affordable. Accordingly, in order to display digital photos, digital photo frames are invented.

Like the traditional photo frames, many DPFs can be either placed on a table or mounted on a wall. However, when people enter a room with a DPF, if the people pay no attention to the DPF, the display of the DPF is ineffective.

Therefore, it is necessary to provide an electronic device and a method to overcome the above-identified deficiency.

### BRIEF DESCRIPTION OF THE DRAWINGS

The components in the drawing is not necessarily drawn to scale, the emphasis instead being placed upon clearly illustrating the principles of the digital photo frame.

The drawing is a block diagram of a digital photo frame in accordance with an exemplary embodiment.

### DETAILED DESCRIPTION

Referring to the drawing, a digital photo frame (DPF) 1 includes a processing unit 10, a motion detector 20, a playback unit 30, a storage unit 40, a display panel 50, a user input unit 60, an interface unit 70 (e.g., an input port or wireless transceiver), and a power source 80. The DPF 1 is capable of automatically prompting a person upon sensing the person in an area around the DPF 1.

The interface unit 70 is configured to connect to an external electronic device (not shown). The external device can be a storage card (e.g., a secure digital SD card, a compact flash CF card) or another electronic device (e.g., a digital camera, a mobile phone, or a computer).

The user input unit 60 is configured to generate instructions in response to user operations. The user input unit 60 can be input keys/buttons, knobs, and the like. The power source 80 is configured to provide power to elements of the DPF 1, such as the processing unit 10, the motion detector 20, the playback unit 30, and the display panel 50. The power source 80 can be a battery or an AC/DC (alternating current to direct current) module.

The storage unit 40 is configured to store medias such as digital pictures, videos, and audio files. The display panel 50 is configured to display the medias. The playback unit 30 is connected to the processing unit 10, and is configured to play the medias.

The motion detector 20, connected to the processing unit 10, is configured for detecting whether there is a person around the DPF 1 within a predetermined area, and producing a trigger signal to the processing unit 10 when there is one. The processing unit 10 is configured to control the playback unit 30 to play an audio file when receiving the trigger signal. In detail, the processing unit 10 obtains an audio file from the storage unit 40, and controls the playback unit 30 to play the audio file. In the embodiment, the processing unit 10 randomly obtains an audio file from the storage unit 40. In other embodiments, the processing unit 10 obtains a particular audio file or a plurality of files in sequence from the storage unit 40. The particular audio file or sequence of files can be set by a user, or provided in the DPF 1 as system defaults.

The motion detector 20 may include any one or more of the following, an infrared detector, a sonar detector, an audio detector, or the like, which can work singly or in combination according to preset parameters to generate a signal when it is likely one or more persons are present in the predetermined area. The DPF 1 is thus useful to provide audio signal to attract people's attention when, for example, a person around the DPF 1 with a predetermined area.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) comprising:
a storage unit configured for storing medias containing audio files;
a playback unit configured for play the audio file;
a motion detector configured for detecting whether there is a person around the DPF and producing a trigger signal when it detects that a person is around the DPF; and
a processing unit configured for controlling the playback unit to play an audio file when receiving the trigger signal.

2. The DPF of claim 1, wherein the processing unit controls the playback unit to randomly play an audio file when receiving the trigger signal.

3. The DPF of claim 1, wherein processing unit controls the playback unit to play a particular audio file or a plurality of files in sequence when receiving the trigger signal, the particular audio file or sequence of the plurality of files can be set by a user or provided in the DPF as system defaults.

4. The DPF of claim 1, wherein the motion detector comprises one selected from the group consisting of an infrared detector, a sonar detector, and an audio detector.

5. The DPF of claim 1, wherein the motion detector comprises two or more detectors selected from the group consisting of an infrared detector, a sonar detector, and an audio detector; the detectors can work singly or in combination according to preset parameters to generate a signal when a person is sensed present in the predetermined area.

6. A method of producing a prompt by a digital photo frame (DPF), the DPF comprising:
a storage unit;
a playback unit;
a motion detector; and
a processing unit;
the method comprising:
detecting whether there is a person around the DPF via the motion detector;
producing a trigger signal when the motion detector detects that there is a person around the DPF; and
controlling the playback unit to play at least one audio file from the storage unit when the processing unit receiving the trigger signal.

7. The method of claim 6, wherein the controlling step comprises:
obtaining a random audio file from the storage unit when the processing unit receiving the trigger signal; and
controlling the playback unit to play the audio file.

8. The method of claim 6, wherein the controlling step comprises:
obtaining a particular audio file or a plurality of audio files in sequence from the storage unit when the processing unit receiving the trigger signal; and
controlling the playback unit to play the audio file or the plurality of audio files.

9. The method of claim 8, wherein the particular audio file or sequence of the plurality of audio files can be set by a user or provided in the DPF as system defaults.
